(19) United States
(12) Patent Application Publication
(10) Pub. No.: US 2012/0056125 A1
(43) Pub. Date: Mar. 8, 2012

(54) INORGANIC SALT HEAT TRANSFER FLUID

(75) Inventors: Justin Raade, San Francisco, CA (US); David Padowitz, Mountain View, CA (US)

(73) Assignee: Halotechnics, Inc, Emeryville, CA (US)

(21) Appl. No.: 13/088,605

(22) Filed: Apr. 18, 2011

Related U.S. Application Data
(60) Provisional application No. 61/325,725, filed on Apr. 19, 2010.
(60) Provisional application No. 61/451,811, filed on Mar. 11, 2011.

(51) Int. Cl. C09K 5/12

(52) U.S. Cl. 252/71

(57) ABSTRACT

Several systems of low melting point mixtures of inorganic salts are disclosed. These compositions can have liquidus temperatures less than 80° C. and thermal stability limits greater than 500° C.

### CROSS-REFERENCES TO RELATED APPLICATIONS

This application claims priority to U.S. Provisional Application Nos. 61/325,725, filed Apr. 19, 2010, and 61/451,811, filed Mar. 11, 2011, which are incorporated in their entirety herein for all purposes.

### STATEMENT AS TO RIGHTS TO INVENTIONS MADE UNDER FEDERALLY SPONSORED RESEARCH AND DEVELOPMENT

This invention was made with Government support under Grant No. DE-FG36-08GO18144, awarded by the Department of Energy Contract to Halotechnics, Inc. The Government has certain rights in this invention.

### BACKGROUND OF THE INVENTION

The present invention describes a heat transfer fluid consisting of a mixture of inorganic salts for use in concentrating solar power (CSP) applications or other high temperature processes. Current commercially available salt-based heat transfer fluids have a high melting point, typically 140° C. or higher. This invention exploits eutectic behavior with a novel composition of materials, resulting in a low melting point below 80° C. The invention is thermally stable up to 500° C.

Concentrating solar power uses mirrors to focus solar energy to boil water and make high pressure steam. The steam subsequently drives a turbine and generator unit to generate electricity. There is a need to bring CSP electricity cost down to the point of being competitive with traditional fossil fuel-based electricity. An advanced low melting point heat transfer fluid (HTF) with a high thermal stability is a key technical advance necessary to reduce the cost of CSP electricity. This novel material would enable higher temperature operation and increased efficiency in converting solar energy to electricity. Increasing the maximum fluid output temperature of current CSP plants from 390° C. to 500° C. would increase the conversion efficiency of the Rankine power block. This improvement would reduce the levelized energy cost [G. J. Kolb, “Conceptual design of an advanced trough utilizing a molten salt working fluid,” presented at SolarPACES Symposium, Las Vegas, Nev. (2008)].

The state of the art HTF used in CSP applications is an organic substance that is a eutectic mixture of biphenyl and diphenyl oxide, sold under the brand names VP-1 and Dowtherm A [“Therminol VP-1 heat transfer fluid by Solutia,” Technical Bulletin 7239115B, Solutia, Inc. (1999)], [“Dowtherm A heat transfer fluid,” Form No. 176-1337-397 AMS, Dow Chemical Company (1997)]. It exhibits a low melting point of 12° C. but is limited to an upper temperature of 390° C. due to thermal degradation. This temperature ceiling limits the thermodynamic efficiency of the Rankine cycle steam turbines driven by the heat from the solar collector field. The organic HTF exhibits a high vapor pressure at elevated temperatures, approximately 10 bar at 390° C., which prevents its use as a thermal energy storage medium. The cost of commercially available organic HTF is quite high.

Molten salts exhibit many desirable heat transfer qualities at high temperatures. They have high density, high heat capacity, high thermal stability, and very low vapor pressure even at elevated temperatures. Their viscosity is low enough for sufficient pumpability at high temperatures, and many are compatible with common stainless steels. Salts of many varieties are currently available in large commercial quantities from several suppliers. There are several commercially available salt formulations, mixtures of nitrates or nitrites sold under the brand name Hitec [“Hitec heat transfer salt,” Coastal Chemical Co., LLC], [“Hitec solar salt,” Coastal Chemical Co., LLC]. A drawback of these molten salts as heat transfer fluids however is their relatively high melting point, typically 140-240° C. The operational risk of a freeze-up if the process temperature drops unexpectedly adds cost to systems that use salt as a heat transfer fluid. Additional hardware must be installed, such as heat tracing, insulation, or emergency water-dilution systems [C. R. Barkhurst and W. P. Manning, “Hitec heat transfer fluid,” Coastal Chemical Co., LLC (2004)]. This high melting point limits the practicality of molten salts as heat transfer fluids in CSP applications. An advanced HTF must exhibit both a low melting point and a high thermal stability. The table below shows the relevant properties of currently available high temperature heat transfer fluids relevant for CSP applications.

### Candidate Heat Transfer Fluids for Concentrating Solar Power Applications.

| | | | Melting | |
|---|---|---|---|---|
| | | | point | Maximum |
| Name | Manufacturer | Components | (liquidus) | temperature |
| VP-1 or | Solutia | biphenyl diphenyl | 12° C. | 400° C. |
| Dowtherm | or Dow | oxide | | |
| A | | | | |
| Hitec XL | Coastal | sodium nitrate | 120° C. | 500° C. |
| | Chemical | potassium nitrate | | |
| | | calcium nitrate | | |
| Hitec | Coastal | sodium nitrate | 142° C. | 538° C. |
| | Chemical | potassium nitrate | | |
| | | sodium nitrite | | |
| Hitec | Coastal | sodium nitrate | 240° C. | 593° C. |
| Solar Salt | Chemical | potassium nitrate | | |

A eutectic mixture exhibits the lowest melting point of any similar mixture with the same components. The change in Gibbs free energy ΔG of a substance at the melting temperature T can be expressed in terms of the change in enthalpy ΔH and the change in entropy ΔS

ΔG=ΔH−TΔS

At equilibrium, ΔG=0 and the melting temperature can be expressed as

$$T = \frac{Δ H}{Δ S}$$

Eutectic mixtures tend to disrupt intermolecular forces (reducing the change in enthalpy) or to increase the disorder generated upon melting (increasing the change in entropy). This leads to a reduction of the melting temperature.

Eutectic behavior is common with binary mixtures of salts, and can be even more dramatic with ternary mixtures. There has been significant work done both on modeling the phase behavior of binary and ternary mixtures of salts, as well as experimentally measuring their behavior [P. L. Lin et al., J. American Ceramic Soc., vol. 62, no. 7-8, pp. 414-422 (1979)], [G. J. Janz et al., NSRDS-NBS 61, parts I, II, and IV (1981)]. An example of a simple binary salt mixture is sodium nitrate and potassium nitrate (NaNO₃ and KNO₃). Sodium nitrate melts at 307° C. and potassium nitrate melts at 337° C. This mixture has a eutectic point at 46 mol % NaNO₃ and 54 mol % KNO₃ which exhibits a drastically reduced melting point of 222° C. This represents a melting point suppression of 85° C. from the lowest melting single component. An example of a ternary salt mixture is sodium nitrate, potassium nitrate, and lithium nitrate (LiNO₃). Lithium nitrate melts at 253° C. The ternary mixture has a eutectic point at 18 mol % NaNO₃, 44.5 mol % KNO₃, and 37.5 mol % LiNO₃ which exhibits a melting point of 120° C. The addition of lithium nitrate to the mixture achieves an additional melting point reduction of 102° C. as compared to the binary mixture.

Eutectic behavior and more drastic melting point reduction occurs with more complex salt mixtures, such as quaternary or higher order mixtures. There is limited experimental data of higher order mixtures; some recent work has been done on novel mixtures of nitrate salts to explore low melting point behavior [R. W. Bradshaw et al., “Molten nitrate salt development for thermal energy storage in parabolic trough solar power systems,” proc. ASME 3rd International Conference on Energy Sustainability, San Francisco, Calif. (2009)]. This work discovered the existence of quaternary mixtures of nitrate salts (with Li, Na, K, and Ca cations) with melting points below 100° C.

It is difficult to accurately model phase behavior of higher order salt mixtures. Detailed material properties of each component must be known, some of which must be measured experimentally. Existing databases of thermodynamic salt properties are incomplete, with many salts of interest (such as nitrates and nitrites) missing. It is therefore typically more straightforward to rely on experimental methods and to directly measure the phase behavior of a system of salts. The large number of possible mixtures with higher order mixtures makes experimental work burdensome, since the number of possible mixtures increases exponentially with the number of components. Eutectic behavior is quite sensitive to the weight percent of each component in the mixture; a deviation of only a few percentage points may have a significant effect on the resulting melting point. If one assumes that each component in a salt mixture can be controlled to the nearest percentage point, then with a two component system there are 101 possible combinations, with a three component system there are 5151 combinations, and with a four component system there are 176,851 combinations. The permutations increase correspondingly when one varies the components to explore different salt systems. The invention described in this document was developing using high throughput experimentation techniques and apparatus, as well as rigorous experiment design methodology in order to overcome the challenge of the large number of possible combinations.

What is needed is a molten salt with a broad operating range (low melting point, high thermal stability). Such molten salts are useful for applications in addition to CSP, such as heat transfer and heat storage with industrial processes, heat treating of metals, and as an electrolyte in thermal batteries. Surprisingly, the present invention meets this and other needs.

### BRIEF DESCRIPTION OF THE DRAWINGS

FIG. 1 shows a quinary phase diagram containing System A, with no chloride content.

FIG. 2 shows a quinary phase diagram containing System B, with no chloride content.

FIG. 3 shows a quinary phase diagram containing System C, with no chloride content.

FIG. 4 shows the data from the thermal stability measurement of Sample 2 in System A.

FIG. 5 shows the data from the thermal stability measurement of Sample 13 in System B.

FIG. 6 shows the data from the thermal stability measurement of Sample 17 in System C.

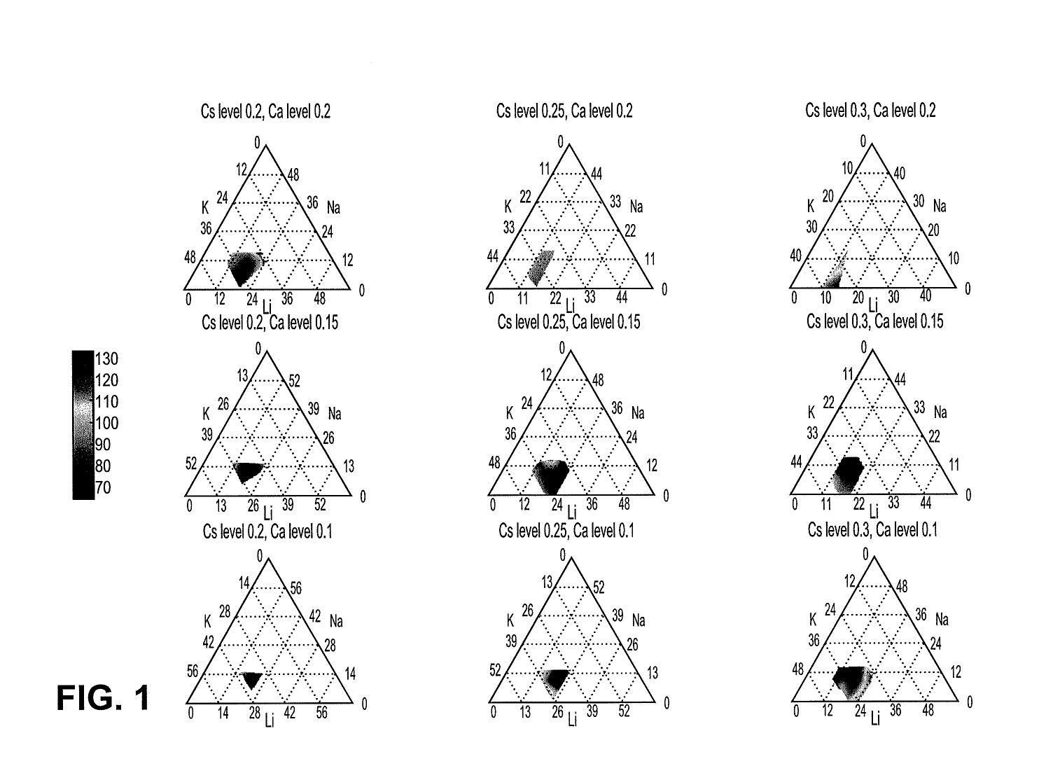

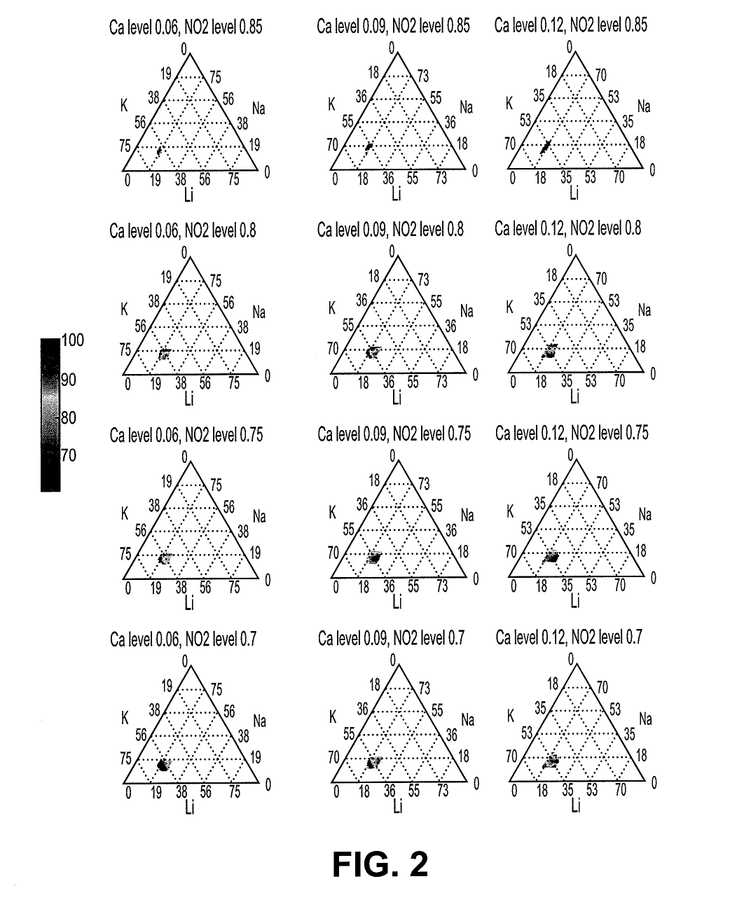

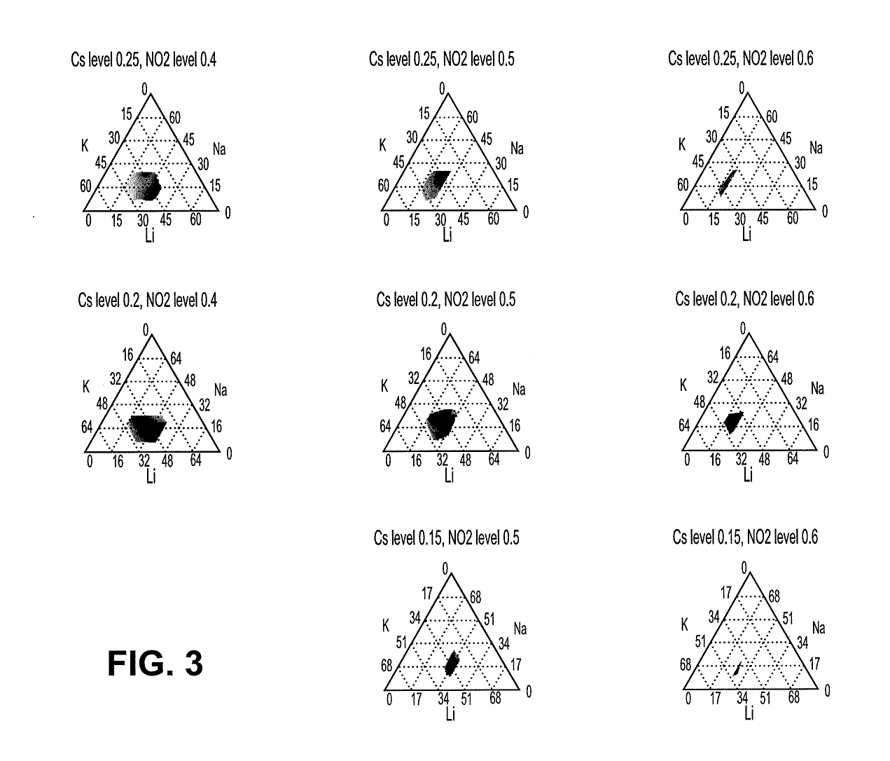

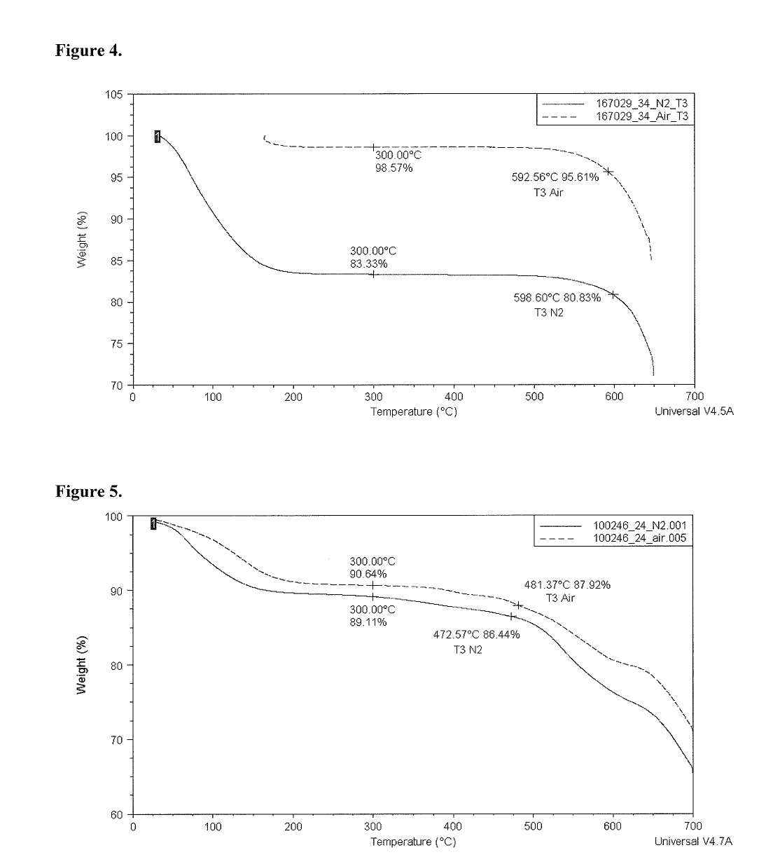

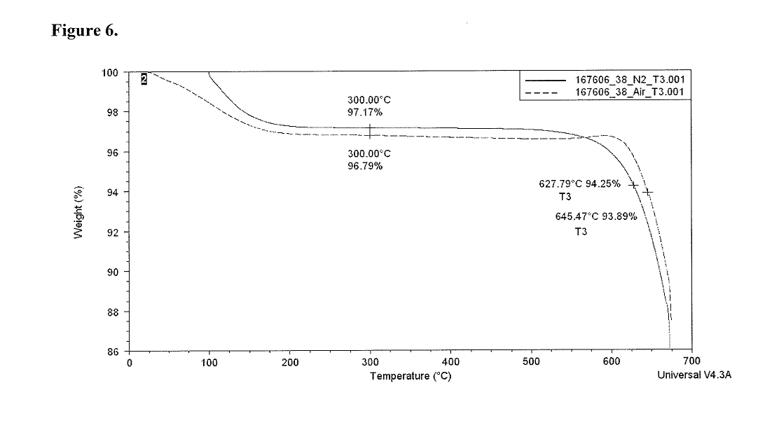

### DETAILED DESCRIPTION OF THE INVENTION

### I. General

The present invention describes a heat transfer fluid consisting of a mixture of inorganic salts for use in concentrating solar power (CSP) applications or other high temperature processes. Current commercially available salt-based heat transfer fluids have a high melting point, typically 140° C. or higher. This invention exploits eutectic behavior with a novel composition of materials, resulting in a low melting point below 80° C. The invention is thermally stable up to 500° C.

A molten salt with a broad operating range (low melting point, high thermal stability) is useful for applications in addition to CSP, such as heat transfer and heat storage with industrial processes, heat treating of metals, and as an electrolyte in thermal batteries.

### II. Definitions

“Cation” refers to chemical elements or counterions having a positive charge. The positive charge can be +1, +2, +3, or greater. Exemplary cations of the present invention include, but are not limited to, Li⁺, K⁺, Na⁺, Ca²⁺, and Cs⁺. Other cations are useful in the present invention.

“Anion” refers to chemical elements and counterions having a negative charge. The negative charge can be −1, −2, −3, or greater. Exemplary anions of the present invention include nitrate (NO₃⁻), nitrite (NO₂⁻) and Cl⁻. Other anions are useful in the present invention.

### III. Compositions

The present invention provides inorganic salt compositions with low melting points and high thermal stability. Additional properties of the invention that are relevant for heat transfer fluid applications include the viscosity, specific heat, thermal conductivity, density, and vapor pressure.

A molten salt with a broad operating range (low melting point, high thermal stability) is useful for applications in addition to CSP, such as heat transfer and heat storage with industrial processes, heat treating of metals, and as an electrolyte in thermal batteries [P. Masset and R. Guidotti, J. Power Sources, vol. 164, pp. 397-414 (2007)]. These applications require the measurement of material properties in addition to those measured for heat transfer applications. For heat treating applications, the chemical interaction of the invention with the heat treated metal must be understood in the relevant temperature range. For electrolyte applications, the ionic conductivity of the invention must be measured as well as the compatibility with anode and cathode materials.

In some embodiments, the present invention provides a composition having a lithium cation, in an amount from about 5 to about 40 mol % based on the cation, and a potassium cation, in an amount from about 20 to about 70 mol % based on the cation. The composition also includes at least two of a sodium cation, in an amount from 0 to about 30 mol % based on the cation, a calcium cation, in an amount from 10 to about 25 mol % based on the cation, or a cesium cation, in an amount of from 10 to about 40 mol % based on the cation. The composition also includes a nitrate anion, in an amount from about 15 to 100 mol % based on the anion, and optionally at least one anion of nitrite, in an amount from 40 to about 90 mol % based on the anion, or chloride, in an amount from 0.1 to about 5 mol % based on the anion. When cesium or calcium is not present, the composition includes nitrite. In some embodiments, the compositions of the present invention are charge neutral, wherein the number of cations and number of anions are such that the composition has no overall charge.

In other embodiments, the composition includes a lithium cation, in an amount from about 5 to about 40 mol % based on the cation, and a potassium cation, in an amount from about 20 to about 70 mol % based on the cation. The composition also includes at least two of a sodium cation, in an amount from 0 to about 30 mol % based on the cation, a calcium cation, in an amount from 10 to about 25 mol % based on the cation, or a cesium cation, in an amount of from 10 to about 40 mol % based on the cation. The composition also includes a nitrate anion, in an amount from about 40 to 100 mol % based on the anion, and optionally at least one anion such as nitrite, in an amount from 40 to about 90 mol % based on the anion, or chloride, in an amount from 0 to about 5 mol % based on the anion. When cesium or calcium is not present, the composition includes nitrite.

In other embodiments, the composition includes lithium, in an amount from about 10 to about 30 mol %, potassium, in an amount from about 25 to about 45 mol %, sodium, in an amount from 0 to about 15 mol %, cesium, in an amount from about 15 to about 35 mol %, calcium, in an amount from about 5 to about 20 mol %, nitrate, in an amount from about 96 to 100 mol % based on the anions, and optionally chloride, in an amount from about 1 to about 4 mol % based on the anions. In some other embodiments, the composition includes sodium, in an amount from about 5 to about 15 mol %.

In still other embodiments, the composition includes lithium, an amount from about 15 to about 30 mol %, potassium, in an amount from about 30 to about 45 mol %, cesium, in an amount from about 20 to about 30 mol %, calcium, in an amount from about 10 to about 20 mol %, nitrate, in an amount from about 96 to 100 mol % based on the anions, and optionally chloride, in an amount from about 1 to about 4 mol % based on the anions. In yet other embodiments, the composition includes chloride, in an amount from about 1 to about 4 mol %.

In some embodiments, the composition includes lithium, in an amount of about 15 mol %, sodium, in an amount of about 10 mol %, potassium, in an amount of about 30 mol %, cesium, in an amount of about 30 mol %, calcium, in an amount of about 15 mol %, and nitrate, in an amount of 100 mol % based on the anions. In other embodiments, the composition includes lithium, in an amount of about 15 mol %, sodium, in an amount of about 10 mol %, potassium, in an amount of about 30 mol %, cesium, in an amount of about 30 mol %, calcium, in an amount of about 15 mol %, nitrate, in an amount of about 97 mol % based on the anions, and chloride, in an amount of about 3 mol % based on the anions.

In other embodiments, the composition includes lithium, in an amount of about 15 mol %, sodium, in an amount of about 10 mol %, potassium, in an amount of about 40 mol %, cesium, in an amount of about 20 mol %, calcium, in an amount of about 15 mol %, nitrate, in an amount of about 97 mol % based on the anions, and chloride, in an amount of about 3 mol % based on the anions.

In some embodiments, the composition includes lithium, in an amount from about 20 to about 30 mol %, sodium, in an amount from about 5 to about 15 mol %, potassium, in an amount from about 40 to about 60 mol %, calcium, in an amount from 5 to about 20 mol %, nitrate, in an amount from about 15 to about 35 mol % based on the anions, nitrite, in an amount from about 65 to about 85 mol % based on the anions, and optionally chloride, in an amount from about 1 to about 3 mol % based on the anions. In other embodiments, the composition includes lithium, in an amount of about 24 mol %, sodium, in an amount of about 11 mol %, potassium, in an amount of about 53 mol %, calcium, in an amount of about 13 mol %, nitrate, in an amount of about 21 mol % based on the anions, and nitrite, in an amount of about 79 mol % based on the anions. In some other embodiments, the composition includes lithium, in an amount of about 26 mol %, sodium, in an amount of about 15 mol %, potassium, in an amount of about 48 mol %, calcium, in an amount of about 12 mol %, nitrate, in an amount of about 24 mol % based on the anions, nitrite, in an amount of about 74 mol % based on the anions, and chloride, in an amount of about 2 mol % based on the anions.

In some embodiments, the composition includes lithium, in an amount from about 20 to about 35 mol %, sodium, in an amount from about 15 to about 25 mol %, potassium, in an amount from about 30 to about 40 mol %, cesium, in an amount from about 10 to about 25 mol %, nitrate, in an amount from about 40 to 55 mol % based on the anions, nitrite, in an amount from about 45 to about 60 mol % based on the anions, and optionally chloride, in an amount from about 0.1 to about 3 mol % based on the anions. In some other embodiments, the composition includes lithium, in an amount of about 24 mol %, sodium, in an amount of about 22 mol %, potassium, in an amount of about 33 mol %, cesium, in an amount of about 21 mol %, nitrate, in an amount of about 45 mol % based on the anions, and nitrite, in an amount of about 55 mol % based on the anions. In still other embodiments, the composition includes, lithium, in an amount of about 28 mol %, sodium, in an amount of about 22 mol %, potassium, in an amount of about 32 mol %, cesium, in an amount of about 18 mol %, nitrate, in an amount of about 46 mol % based on the anions, nitrite, in an amount of about 53 mol % based on the anions, and chloride, in an amount of about 1 mol % based on the anions.

The compositions of the present invention can have any suitable melting point. In some embodiments, the melting point can be less than about 150° C., or less than about 100, 90, 80, 70 or 60° C. In other embodiments, the composition has a melting point less than about 80° C.

The compositions of the present invention can have any suitable thermal stability limit. In some embodiments, the thermal stability limit is greater than about 400° C., or greater than about 450, 500, 550, 600, 650 or 700° C. In some other embodiments, the composition has a thermal stability limit greater than about 500° C.

The compositions of the present invention can be prepared by any method known to one of skill in the art. Salt mixtures were formulated and characterized with an automated materials discovery workflow. The first step was to prepare free flowing anhydrous salt components. Components were purchased in reagent grade purity, typically 99% pure, from Sigma Aldrich (St. Louis, Mo.). Each component that was available in anhydrous form was ground with a mortar and pestle and dehydrated in an oven at 115° C. for at least 12 hours. Calcium nitrate was procured in a tetrahydrate form and was not dehydrated prior to dispensing. Potassium nitrite and calcium nitrite were prepared as aqueous solutions and were not dehydrated prior to dispensing. Salt mixtures were formulated using automated robotic systems for both powder dispense and liquid dispense. The powder dispense system was the MTM Powdernium from Symyx Technologies (Sunnyvale, Calif.). This device measures each component as it is being dispensed and records the final weight with high accuracy. It can dispense many different components to many different mixtures. The liquid dispense system was the Synthesis Station Core Module from Symyx. Components were typically dispensed as powder, but potassium nitrite was dispensed as an aqueous solution because it is very hygroscopic and tends to form clumps when in powder form. Calcium nitrite was only available from suppliers as an aqueous solution and was dispensed in this form. The mixtures were dispensed into a borosilicate glass plate containing 96 wells in an 8 by 12 array. Each mixture had a total mass of 250 mg. After dispensing, the plate was placed in a furnace purged with nitrogen gas and heated to 400° C. for at least 8 hours in order to ensure complete melting and homogenization of each mixture. Mixtures that contained hydrated components or water were first held at 150° C. for at least 4 hours to boil off the water without spitting. After melting the plate was allowed to cool and stored in a dessicator until subsequent testing. The melting point of each mixture was measured with a Parallel Melting Point Workstation (PMP) from Symyx Technologies (Sunnyvale, Calif.). The PMP allows the melting point for each mixture in the 96 well plate to be measured simultaneously. The PMP heats the plate at a controlled rate and uses an optical method to record the temperature at which each mixture transitions from opaque to clear. This transition corresponds to the liquidus temperature, which is defined as the temperature during heating at which the last remaining solid phase melts and becomes liquid. The liquidus temperature is also equivalent to the temperature during cooling at which a solid phase first appears in the melt (assuming no supercooling). However, supercooling is common with molten salts and therefore only data acquired during a heating mode was used to obtain the melting point. The melting point in this invention was defined as the liquidus temperature.

The phase diagram is a graphical device that allows the composition and melting point of mixtures to be represented simultaneously (this type of phase diagram is called a polythermal projection). The typical phase diagram is triangular, which allows the plotting of a ternary system of three salts (typically four ions). Each corner of the triangle represents a pure ion and the interior area represents mixtures of varying proportions. The color represents the melting point. A quaternary system of four salts (typically five ions) may be plotted by a series of triangular phase diagrams [Phase Diagrams for Ceramists, vol. 1 talks about this in the introductory material, for up to 6 ions.]. The location of each ternary diagram along a horizontal axis represents the proportion of the 5th ion. A quinary system of five salts (typically six ions) may be plotted by a two dimensional surface of ternary phase diagrams. Each ternary phase diagram is located at the (x, y) coordinates corresponding to the level of the 5th and 6th ions (ion 5, ion 6). A system of six salts (typically seven ions) may be plotted by a series of two dimensional surfaces of ternary phase diagrams. Each surface represents a constant value of the 7th ion. The drawings of this invention include representative phase diagrams from each of the major systems disclosed.

Mixtures that exhibited a low melting point were subjected to further testing for thermal stability. Approximately 20 mg of each mixture was scraped from its well in the glass plate and loaded onto a platinum pan for testing. The thermal stability of mixtures was measured using a Q500 thermogravimetric analysis (TGA) device from TA Instruments (New Castle, Del.). A TGA device heats a sample in a controlled environment and continuously measures the sample weight, which typically decreases at higher temperatures as the sample decomposes into gaseous products. The maximum temperature or thermal stability of a sample, termed ‘T3’, was defined for screening purposes as the temperature at which it has lost 3% of its anhydrous weight during a TGA test ramping at 10° C./min. The anhydrous weight of a salt sample was defined as the weight at 300° C. during the TGA test. Initial weight loss below 300° C. is due to absorbed water evaporating from the sample. Each mixture was tested in two atmospheres, one of air and one of nitrogen, in order to observe the effect of oxidation. The thermal stability using the T3 method typically produces similar results for each mixture in a given system; however significant differences are observed between systems. Therefore only a representative set of mixtures from each system were tested for thermal stability rather than every mixture in the system. Mixtures with only nitrate typically have similar T3 values for air and nitrogen atmospheres. Mixtures containing nitrate/nitrite typically have a higher T3 value when tested in air. This is likely due to oxidation of the nitrite ion to nitrate, producing an increase in weight and masking the effect of weight loss due to thermal decomposition. For this reason the T3 value in nitrogen is considered more useful for nitrate/nitrite mixtures. The T3 method ranks the mixtures in order of relative stability rather than acting as an absolute measurement of stability. In other words, this methodology does not provide a definitive prediction of the salt's long-term thermal stability in a real-life application. It is primarily a laboratory-scale screening test that gives a comparative ranking of candidate salt mixtures.

The following examples each illustrate an embodiment of salt systems described in this invention. They are described by specifying the mass of each salt component, which can be translated to molar percent of each ion by those skilled in the art. A salt mixture of any desired size with the same properties (melting point and thermal stability) can be prepared by increasing the amount of each component but maintaining the relative proportions. The examples with salt masses are given for simplicity but do not embody an exclusive method to achieve a given composition of ions; to exclusively describe a molten salt composition one must specify the ionic composition. For example, in a target ionic composition with several cations and with anions primarily of nitrate but with a minority of chloride, the chloride ion may be achieved by adding sodium chloride (NaCl) or potassium chloride (KCl) and adjusting the cations accordingly to achieve the equivalent ionic composition.

### IV. Examples

### Example 1

To prepare a laboratory scale salt mixture, 18.6 mg of LiNO₃, 14.4 mg of NaNO₃, 53.4 mg of KNO₃, 102.7 mg of CsNO₃ and 62.1 mg of Ca(NO₃)₂-4H₂O was dispensed into a well on a borosilicate glass plate. The sample was heated in a nitrogen-purged furnace at a temperature of 150° C. for 4 hours to dehydrate the components, then the temperature was increased to 400° C. for 8 hours to melt and homogenize the sample. The sample was maintained at 115° C. after melting until it was removed from the furnace and allowed to cool to room temperature in a dessicator. The sample was inserted into the PMP Workstation and the temperature was set to 50° C. and allowed to stabilize for 30 minutes. The temperature was then ramped to 200° C. at 20° C./hour. After measuring the melting point, 20 mg of the sample was removed and placed onto a platinum pan. The pan was loaded into the TGA and the temperature was ramped from ambient to 700° C. at 10° C./min using air as the purge gas. The TGA test was repeated with another 20 mg from the sample using nitrogen as the purge gas. The melting point of this mixture was 65° C. The thermal stability results can be seen in Table 1. This example corresponds to Sample 1.

### Example 2

The procedure from Example 1 was repeated using 18 mg of LiNO₃, 15.3 mg of NaNO₃, 48.4 mg of KNO₃, 104.4 mg of CsNO₃, 61.7 mg of Ca(NO₃)₂-4H₂O, and 4.8 mg of KCl. The melting point of this mixture was 65° C. No TGA test was performed. This example corresponds to Sample 5.

### Example 3

The procedure from Example 1 was repeated using 20.1 mg of LiNO₃, 15.9 mg of NaNO₃, 71.8 mg of KNO₃, 72.8 mg of CsNO₃, 66.9 mg of Ca(NO₃)₂-4H₂O, and 4.1 mg of KCl. The melting point of this mixture was 66° C. The thermal stability results can be seen in Table 1. This example corresponds to Sample 6.

### Example 4

The procedure from Example 1 was repeated using 47.6 mg of LiNO₃, 21.3 mg of NaNO₂, 132.3 mg of KNO₂ from a 40 weight percent aqueous solution, and 48.9 mg of Ca(NO₂)₂ from a 30 weight percent aqueous solution. The melting point of this mixture was 61° C. The thermal stability results can be seen in Table 1. This example corresponds to Sample 9.

### Example 5

The procedure from Example 1 was repeated using 52.9 mg of LiNO₃, 30.7 mg of NaNO₂, 2.7 mg of KNO₃, 113.7 mg of KNO₂ from a 40 weight percent aqueous solution, 47 mg of Ca(NO₂)₂ from a 30 weight percent aqueous solution, and 4.6 mg of KCl. The melting point of this mixture was 53° C. The thermal stability results can be seen in Table 1. This example corresponds to Sample 13.

### Example 6

The procedure from Example 1 was repeated using 41.9 mg of LiNO₃, 38.5 mg of NaNO₂, 70.3 mg of KNO₂ from a 40 weight percent aqueous solution, and 103.7 mg of CsNO₃. The melting point of this mixture was 72° C. The thermal stability results can be seen in Table 1. This example corresponds to Sample 17.

### Example 7

The procedure from Example 1 was repeated using 50.5 mg of LiNO₃, 39.9 mg of NaNO₂, 69.9 mg of KNO₂ from a 40 weight percent aqueous solution, 92.8 mg of CsNO₃, and 2.2 mg of KCl. The melting point of this mixture was 72° C. No TGA test was performed. This example corresponds to Sample 21.

Further examples of each system are given below in Table 1. The composition of each is expressed in molar percent on an ion basis, which can be converted to weight percent by those skilled in the art. The melting point and the maximum temperature in air and nitrogen are expressed in degrees Celsius.

TABLE 1
Composition, melting point, and maximum temperature (thermal stability)
data where available on embodiments of the invention. Composition is given in molar
percent on an ion basis. Temperatures are in degrees Celsius.

| | | | | | | | | | | mp | Tmax | Tmax |
|---|---|---|---|---|---|---|---|---|---|---|---|---|
| System | Sample | Li | Na | K | Cs | Ca | NO₃ | NO₂ | Cl | (° C.) | (Air, ° C.) | (N₂, ° C.) |
| A | 1 | 15% | 10% | 30% | 30% | 15% | 100% | 0% | 0% | 65 | 561 | 563 |
| | 2 | 25% | 0% | 35% | 25% | 15% | 100% | 0% | 0% | 71 | 593 | 599 |
| | 3 | 20% | 5% | 33% | 30% | 12% | 100% | 0% | 0% | 74 | | |
| | 4 | 24% | 10% | 34% | 22% | 10% | 100% | 0% | 0% | 75 | 594 | 581 |
| | 5 | 15% | 10% | 30% | 30% | 15% | 97% | 0% | 3% | 65 | | |
| | 6 | 15% | 10% | 40% | 20% | 15% | 97% | 0% | 3% | 66 | 564 | 583 |
| | 7 | 21% | 0% | 40% | 25% | 15% | 98% | 0% | 2% | 68 | 592 | |
| | 8 | 15% | 5% | 35% | 30% | 15% | 98% | 0% | 2% | 68 | 575 | |
| B | 9 | 24% | 11% | 53% | 0% | 13% | 21% | 79% | 0% | 61 | 514 | 474 |
| | 10 | 25% | 15% | 48% | 0% | 12% | 30% | 70% | 0% | 65 | | |
| | 11 | 21% | 11% | 56% | 0% | 11% | 19% | 81% | 0% | 65 | | |
| | 12 | 25% | 15% | 48% | 0% | 12% | 25% | 75% | 0% | 66 | | |
| | 13 | 26% | 15% | 48% | 0% | 12% | 24% | 74% | 2% | 53 | 481 | 473 |
| | 14 | 22% | 11% | 53% | 0% | 13% | 20% | 78% | 2% | 58 | | |
| | 15 | 25% | 15% | 48% | 0% | 12% | 24% | 75% | 1% | 58 | | |
| | 16 | 20% | 15% | 53% | 0% | 12% | 18% | 80% | 2% | 59 | | |
| C | 17 | 24% | 22% | 33% | 21% | 0% | 45% | 55% | 0% | 72 | 645 | 628 |
| | 18 | 25% | 21% | 36% | 17% | 0% | 43% | 57% | 0% | 75 | 646 | 603 |
| | 19 | 28% | 18% | 35% | 18% | 0% | 47% | 53% | 0% | 76 | 626 | 602 |
| | 20 | 34% | 18% | 35% | 13% | 0% | 47% | 53% | 0% | 76 | 633 | 566 |
| | 21 | 28% | 22% | 32% | 18% | 0% | 46% | 53% | 1% | 72 | | |
| | 22 | 28% | 22% | 33% | 18% | 0% | 45% | 53% | 2% | 72 | | |
| | 23 | 31% | 19% | 34% | 16% | 0% | 47% | 52% | 1% | 72 | | |
| | 24 | 30% | 21% | 35% | 15% | 0% | 45% | 55% | 0.3% | 73 | | |

System A:

| | | | | | |
|---|---|---|---|---|---|
| Cation | Li | Na | K | Cs | Ca |
| mol % | 15-25 | 0-10 | 30-40 | 22-30 | 10-15 |
| Anion | NO₃ | Cl | | | |
| mol % | 96-100 | 0-4 | | | |

System B:

| | | | | |
|---|---|---|---|---|
| Cation | Li | Na | K | Ca |
| mol % | 20-26 | 11-15 | 48-56 | 11-13 |
| Anion | NO₃ | NO₂ | Cl | |
| mol % | 18-30 | 70-81 | 0-4 | |

System C:

| | | | | |
|---|---|---|---|---|
| Cation | Li | Na | K | Cs |
| mol % | 24-34 | 18-22 | 32-36 | 13-21 |
| Anion | NO₃ | NO₂ | Cl | |
| mol % | 43-47 | 52-57 | 0-4 | |

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

What is claimed is:

1. A composition comprising:
a lithium cation, in an amount from about 5 to about 40 mol % based on the cation;
a potassium cation, in an amount from about 20 to about 70 mol % based on the cation;
at least two members selected from the group consisting of:
a sodium cation, in an amount from 0 to about 30 mol % based on the cation,
a calcium cation, in an amount from 10 to about 25 mol % based on the cation, and
a cesium cation, in an amount of from 10 to about 40 mol % based on the cation;
a nitrate anion, in an amount from about 15 to 100 mol % based on the anion; and optionally at least one anion selected from the group consisting of
nitrite, in an amount from 40 to about 90 mol % based on the anion, and
chloride, in an amount from 0.1 to about 5 mol % based on the anion, wherein when cesium or calcium is not present, the composition comprises nitrite.

2. The composition of claim 1, comprising:
a lithium cation, in an amount from about 5 to about 40 mol % based on the cation;
a potassium cation, in an amount from about 20 to about 70 mol % based on the cation;
at least two members selected from the group consisting of:
a sodium cation, in an amount from 0 to about 30 mol % based on the cation,
a calcium cation, in an amount from 10 to about 25 mol % based on the cation, and
a cesium cation, in an amount of from 10 to about 40 mol % based on the cation;
a nitrate anion, in an amount from about 40 to 100 mol % based on the anion; and optionally at least one anion selected from the group consisting of
nitrite, in an amount from 40 to about 90 mol % based on the anion, and
chloride, in an amount from 0 to about 5 mol % based on the anion, wherein when cesium or calcium is not present, the composition comprises nitrite.

3. The composition of claim 1, comprising:
lithium, in an amount from about 10 to about 30 mol %;
potassium, in an amount from about 25 to about 45 mol %;
sodium, in an amount from 0 to about 15 mol %;
cesium, in an amount from about 15 to about 35 mol %;
calcium, in an amount from about 5 to about 20 mol %;
nitrate, in an amount from about 96 to 100 mol % based on the anions; and
optionally chloride, in an amount from about 1 to about 4 mol % based on the anions.

4. The composition of claim 3, comprising sodium, in an amount from about 5 to about 15 mol %.

5. The composition of claim 3, comprising:
lithium, an amount from about 15 to about 30 mol %;
potassium, in an amount from about 30 to about 45 mol %;
cesium, in an amount from about 20 to about 30 mol %;
calcium, in an amount from about 10 to about 20 mol %;
nitrate, in an amount from about 96 to 100 mol % based on the anions; and
optionally chloride, in an amount from about 1 to about 4 mol % based on the anions.

6. The composition of claim 3, comprising chloride, in an amount from about 1 to about 4 mol %.

7. The composition of claim 3, wherein the composition comprises:
lithium, in an amount of about 15 mol %;
sodium, in an amount of about 10 mol %;
potassium, in an amount of about 30 mol %;
cesium, in an amount of about 30 mol %;
calcium, in an amount of about 15 mol %; and
nitrate, in an amount of 100 mol % based on the anions.

8. The composition of claim 3, wherein the composition comprises:
lithium, in an amount of about 15 mol %;
sodium, in an amount of about 10 mol %;
potassium, in an amount of about 30 mol %;
cesium, in an amount of about 30 mol %;
calcium, in an amount of about 15 mol %;
nitrate, in an amount of about 97 mol % based on the anions; and
chloride, in an amount of about 3 mol % based on the anions.

9. The composition of claim 3, wherein the composition comprises:
lithium, in an amount of about 15 mol %;
sodium, in an amount of about 10 mol %;
potassium, in an amount of about 40 mol %;
cesium, in an amount of about 20 mol %;
calcium, in an amount of about 15 mol %;
nitrate, in an amount of about 97 mol % based on the anions; and
chloride, in an amount of about 3 mol % based on the anions.

10. The composition of claim 1, comprising:
lithium, in an amount from about 20 to about 30 mol %;
sodium, in an amount from about 5 to about 15 mol %;
potassium, in an amount from about 40 to about 60 mol %;
calcium, in an amount from 5 to about 20 mol %;
nitrate, in an amount from about 15 to about 35 mol % based on the anions;
nitrite, in an amount from about 65 to about 85 mol % based on the anions; and
optionally chloride, in an amount from about 1 to about 3 mol % based on the anions.

11. The composition of claim 10, wherein the composition comprises:
lithium, in an amount of about 24 mol %;
sodium, in an amount of about 11 mol %;
potassium, in an amount of about 53 mol %;
calcium, in an amount of about 13 mol %;
nitrate, in an amount of about 21 mol % based on the anions; and
nitrite, in an amount of about 79 mol % based on the anions.

12. The composition of claim 10, wherein the composition comprises:
lithium, in an amount of about 26 mol %;
sodium, in an amount of about 15 mol %;
potassium, in an amount of about 48 mol %;
calcium, in an amount of about 12 mol %;
nitrate, in an amount of about 24 mol % based on the anions;
nitrite, in an amount of about 74 mol % based on the anions; and
chloride, in an amount of about 2 mol % based on the anions.

13. The composition of claim 1, comprising:
lithium, in an amount from about 20 to about 35 mol %;
sodium, in an amount from about 15 to about 25 mol %;
potassium, in an amount from about 30 to about 40 mol %;
cesium, in an amount from about 10 to about 25 mol %;
nitrate, in an amount from about 40 to 55 mol % based on the anions;
nitrite, in an amount from about 45 to about 60 mol % based on the anions; and
optionally chloride, in an amount from about 0.1 to about 3 mol % based on the anions.

14. The composition of claim 13 wherein the composition comprises:
lithium, in an amount of about 24 mol %;
sodium, in an amount of about 22 mol %;
potassium, in an amount of about 33 mol %;
cesium, in an amount of about 21 mol %;
nitrate, in an amount of about 45 mol % based on the anions; and
nitrite, in an amount of about 55 mol % based on the anions.

15. The composition of claim 13, wherein the composition comprises:
lithium, in an amount of about 28 mol %;
sodium, in an amount of about 22 mol %;
potassium, in an amount of about 32 mol %;
cesium, in an amount of about 18 mol %;
nitrate, in an amount of about 46 mol % based on the anions;
nitrite, in an amount of about 53 mol % based on the anions; and
chloride, in an amount of about 1 mol % based on the anions.

16. The composition of claim 1, wherein the melting point is less than about 80° C.

17. The composition of claim 1, wherein the thermal stability limit is greater than about 500° C.
